(19) United States
(12) Patent Application Publication
(10) Pub. No.: US 2024/0035550 A1
(43) Pub. Date: Feb. 1, 2024

(54) CONTROL DEVICE

(71) Applicant: Rolls-Royce Deutschland Ltd & Co KG, Blankenfelde-Mahlow (DE)

(72) Inventor: Jens WEIDAUER, Fürth (DE)

(21) Appl. No.: 18/039,779

(22) PCT Filed: Nov. 29, 2021
(86) PCT No.: PCT/EP2021/083382

§ 371 Date: Jun. 1, 2023

(30) Foreign Application Priority Data
Dec. 2, 2020 (DE) 10 2020 132 002.7

(51) Int. Cl. F16H 25/20; F16H 25/24; B64C 11/44; B64C 11/32

(52) U.S. Cl. CPC F16H 25/205; F16H 25/24; B64C 11/44; B64C 11/32; F16H 2025/2075; F16H 2025/2084

(57) ABSTRACT

A control device includes a mechanical system for moving a mechanical slide. The control device further includes a first electric drive configured to receive a position target value and to drive the mechanical system to move the mechanical slide to the position target value. The control device also includes a second electric drive configured to receive the same position target value and to drive the mechanical system to move the mechanical slide to the position target value. The two electric drives are provided and configured to jointly and simultaneously drive the mechanical system and, upon the other electric drive failing, to drive the mechanical system alone and, upon their own failure, not to obstruct the mechanical system from then being driven only by the other electric drive.

The present patent document is a § 371 nationalization of PCT Application Serial No. PCT/EP2021/083382, filed Nov. 29, 2021, designating the United States, which is hereby incorporated by reference, and this patent document also claims the benefit of German Patent Application No. 10 2020 132 002.7, filed Dec. 2, 2020.

### TECHNICAL FIELD

The disclosure relates to an actuating device. The actuating device is particularly suitable and intended for adjusting the blade angles of the propeller blades of an aircraft propeller.

### BACKGROUND

Aircraft propellers are known which have a blade winding adjustment mechanism to control the propeller power. A hydraulics system is used to adjust the blade angles of the propeller blades, the hydraulics system receiving a setpoint value for the blade angle position via the position of a mechanical slide, which in turn is actuated via an actuating drive. The actuating drive receives a position setpoint value for the mechanical slide from an aircraft controller, so that the aircraft controller may directly adjust the blade angle of the propeller blades of the aircraft propeller.

However, in the event that the actuating drive fails, the blade angle adjustment mechanism is no longer functional.

### SUMMARY AND DESCRIPTION

The present disclosure is based on the object of providing an actuating device, in particular for adjusting the blade angles of the propeller blades of an aircraft propeller, which actuating device effectively provides redundancy in the event that an actuating drive fails.

This object is achieved by an actuating device and a device as disclosed herein. The scope of the present disclosure is defined solely by the appended claims and is not affected to any degree by the statements within this summary. The present embodiments may obviate one or more of the drawbacks or limitations in the related art.

An actuating device is provided, wherein the actuating device is suitable for adjusting the blade angles of the propeller blades of an aircraft propeller. The actuating device includes a mechanical system configured to move a mechanical slide. The actuating device further includes a first electric drive for driving the mechanical system, wherein the first electric drive is configured to receive a position setpoint value and drive the mechanical system to move the mechanical slide to the position setpoint value.

The actuating device further includes a second electric drive for driving the mechanical system, wherein the second electric drive is configured to receive the same position setpoint value and drive the mechanical system to move the mechanical slide to the position setpoint value. In this example, the first electric drive and the second electric drive are configured to drive the mechanical system jointly and simultaneously, the first electric drive and the second electric drive are configured to drive the mechanical system alone in the event that the other electric drive fails, and the first electric drive and the second electric drive are configured, in the event that one of the electric drives fails, to not inhibit driving of the mechanical system, which is then performed only by the other electric drive.

The disclosure is based on the idea of providing redundancy in that the actuating device has two electric drives, which are operated simultaneously and which both receive the same position setpoint value for the position of the mechanical slide. In the absence of a fault, the two electric drives drive the mechanical system jointly and simultaneously. Each drive of the two electric drives is monitored separately and independently of the other electric drive and switched off in the event of a fault. The switched-off actuating drive then no longer develops any torque and is no longer involved in driving the mechanical system. At the same time, the respective electric drive is configured in such a way that, in the event that the drive is switched off, it does not inhibit driving of the mechanical system, which is then further performed only by the other electric drive.

The redundancy provided by the actuating device with regard to the electric drive is distinguished in that there are no switchover processes in the event that an electric drive fails, as would be the case if an electric backup drive were used for redundancy. Rather, the present disclosure makes it possible to achieve position control of the mechanical slide without interruption even in the event that an electric drive fails. In this case, the two electric drives work independently of each other.

One refinement provides that the mechanical system is configured as a threaded spindle and includes a spindle rod and a spindle nut. In this case, the two electric drives drive the spindle rod jointly. The spindle nut arranged on the spindle rod is connected to the mechanical slide. The spindle nut is moved linearly along the spindle rod when the spindle rod is rotated about its longitudinal axis by the two electric drives. In this way, when the spindle rod is driven, the mechanical slide may be moved to the position setpoint value.

The design of the mechanical system as a threaded spindle is an example of a mechanical system in which the mechanical slide is moved linearly. In principle, however, other mechanical systems are also conceivable, which provide linear adjustment of the position of the mechanical slide, for example, using a guide rail on which a carriage coupled to the mechanical slide may be moved. In principle, rotary systems are also conceivable, in which a mechanical slide is moved, for example, along an arc of a circle by the mechanical system.

When the mechanical system is designed as a threaded spindle, one design variant provides that the two electric drives are arranged at opposite ends of the threaded spindle. This enables the drive force to be introduced symmetrically into the threaded spindle. As an alternative, the two electric drives are arranged one behind the other at the same end of the threaded spindle.

A further refinement provides that the mechanical slide is connected to a hydraulics system, which adjusts the blade angle of the propeller blades of an aircraft propeller depending on the position of the mechanical slide. In this case, the position of the mechanical slide represents, for example, a reference variable for hydraulic control of the blade angle, with the reference variable indicating the setpoint value for the blade angle. The position setpoint value of the mechanical slide therefore determines the setpoint value for the blade angle of the propeller blades, wherein the position setpoint value of the mechanical slide clearly determines the setpoint value for the blade angle of the propeller blades. The blade angle of the propeller (or the corresponding blade angles of the individual propeller blades) may therefore be adjusted via the position setpoint value of the mechanical slide.

One refinement provides that the two electric drives both have a position control system, wherein the position actual value of the mechanical slide is controlled to the position setpoint value via the position control system of the respective electric drive. Position control systems are known to a person skilled in the art. They include detecting the position actual value, (e.g., by a sensor) and controlling the position actual value of the actuator (e.g., the mechanical slide) to the specified position setpoint value. The relevant control loop may include nesting of a position control loop, rotation speed control loop and current control loop here.

One refinement in this respect provides that the first electric drive and the second electric drive implement position control in each case with a static function, which causes the mechanical slide to be controlled to the position setpoint value with a tolerance value, wherein, for example, the position control system assumes that the position setpoint value has been reached when the position setpoint value plus/minus the tolerance value is reached. Such a static function provides that the two electric drives do not work against each other in the event of deviations in the position actual values of the two electric drives. This is because if, for example, one electric drive receives via its position control system the information that the position actual value is equal to the position setpoint value, then it will counteract a further adjustment of the mechanical slide. If, at the same time, the other electric drive receives via its position control system the information that the position actual value is not yet equal to the position setpoint value, then it will want to change the position actual value of the mechanical slide. This combination would result in the two electric drives working against each other.

In order to avoid this, it may be provided, in particular, that the tolerance value reduces the position setpoint value depending on the current torque or power requirement of the electric drive. As the torque increases, thus indicating that the two electric drives are working against each other, the position setpoint value should therefore be reduced. It may also be provided here that a factor k, by which the position setpoint value is reduced depending on the current torque or power requirement of the electric drive, is identical for both electric drives. This provides that the two electric drives move to the middle position in the event of deviations in the position actual values, without the electric drives being loaded up to their power limits.

As already mentioned, the position actual value of the position control system is measured, for example, by at least one sensor. Here, a sensor, which feeds the position actual value to both position control systems, may be provided or each of the position control systems includes its own sensor, which determines the position actual value. The latter configuration, with each system including its own sensor, may be advantageous in allowing for complete independence of the two position control systems and reliable redundancy in the event of a failure.

One refinement provides that the two electric drives each include an electric motor, which is coupled to the mechanical system without a self-locking mechanism. The electric motors are therefore connected to the common mechanical system (for example, a threaded spindle) without a self-locking mechanism. This provides that an inactive electric drive may be moved by an active electric drive.

A further refinement provides that the first electric drive and the second electric drive are each assigned a monitoring module, which monitors the assigned drive independently of the other drive and switches it off in the event of a fault being identified. The monitoring functions are implemented redundantly here and work independently of one another.

In order to also be able to identify a sensor fault when determining the actual position of the mechanical slide, one development provides that each electric drive is assigned a second position sensor, which additionally detects the position actual value of the mechanical slide, wherein the position actual value detected by the second position sensor is read in by the respective monitoring module. In this case, the monitoring module is configured to identify a possible malfunction from the position actual value of the position control system and the position actual value detected by the second position sensor and possibly also from the current actual value of the electric drive and to switch off the corresponding electric drive in this case.

The position setpoint value of the mechanical slide is provided, for example, via an aircraft control system. The aircraft control system may directly adjust the blade angle of the propeller blades of the propeller via the position setpoint value of the mechanical slide.

The actuating device may be expanded to include further electric drives and is easily scalable. For example, it may be provided that the actuating device has at least one further electric drive, wherein the further electric drive is intended to receive the same position setpoint value as the two other electric drives and likewise to drive the mechanical system so that the mechanical slide is moved to the position setpoint value.

According to a further aspect, a device for adjusting the blade angles of the propeller blades of an aircraft propeller is disclosed. The device includes: a propeller with a plurality of propeller blades, the blade angles of which may be adjusted; a hydraulics system configured to adjust the blade angles of the propeller blades; and a device as described herein, wherein the hydraulics system receives a blade angle setpoint value via the position of the mechanical slide.

The hydraulics system may likewise include a control system here.

### BRIEF DESCRIPTION OF THE DRAWINGS

The disclosure will be explained in more detail below on the basis of a plurality of embodiments with reference to the figures of the drawing, in which:

FIG. 1 depicts an embodiment of an actuating device for adjusting the blade angles of the propeller blades of an aircraft propeller, wherein the actuating device has two electric drives, which jointly drive a mechanical system configured as a threaded spindle and connected to a mechanical slide;

FIG. 2 depicts an embodiment of a control system of the electric drives of the actuating device of FIG. 1;

FIG. 3 depicts an implementation variant of an actuating device according to FIG. 1, in which each electric drive is assigned a motor controller and a monitoring unit; and

FIG. 4 depicts an actuating device for adjusting the blade angles of the propeller blades of an aircraft propeller according to the prior art.

### DETAILED DESCRIPTION

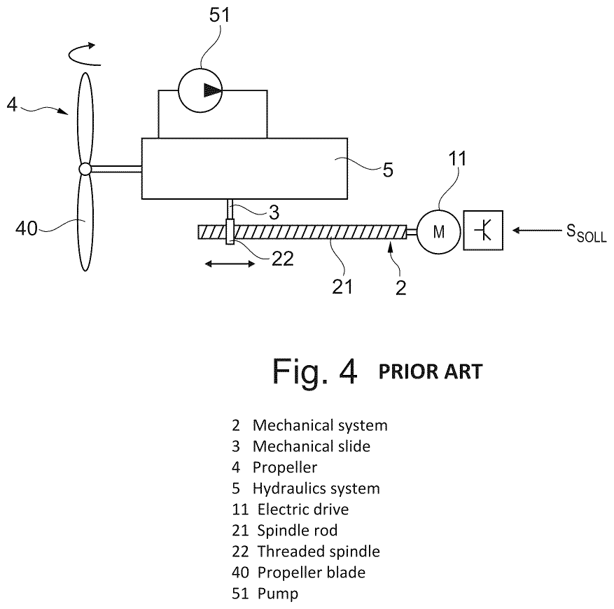

For better understanding of the background of the present disclosure, an actuating device for adjusting the blade angles of the propeller blades of an aircraft propeller according to the prior art will first be explained with reference to FIG. 4.

The actuating device of FIG. 4 enables the blade angles of the propeller blades 40 of a propeller 4 to be adjusted. All the propeller blades 40 have the same blade angle here. Such blade angle adjustment is used to control the propeller power. The blade angle is adjusted via a hydraulics system 5, which includes a hydraulic circuit with a pump 51 and a control valve (not shown separately), wherein the hydraulic circuit and therefore the blade angle may be adjusted via the control valve. In this case, the control valve may be adjusted via a mechanical slide 3, so that the blade angle may be adjusted via the position of the mechanical slide 3.

The mechanical slide 3 may, in turn, be actuated via a mechanical system 2 and an electric drive 11, wherein the mechanical system 2 is configured as a threaded spindle, which includes a spindle rod 21 and a spindle nut 22, in the example shown. The electric drive 11 includes an electric motor. The electric motor causes the spindle rod 21 to rotate, wherein the rotational movement of the electric motor is converted into a linear movement of the spindle nut 22. The spindle nut 22 is connected to the mechanical slide 3, so that the mechanical slide 3 is moved linearly together with the spindle nut 22 and the mechanical slide 3 may therefore be moved to a desired position via the electric drive 11. It is provided here that the electric drive 11 is supplied with a position setpoint value S_{Soll} by an aircraft controller.

The electric drive 11 is equipped with a position control system, which controls the position of the mechanical slide 3 to the position setpoint value S_{Soll} specified by the aircraft controller, so that the aircraft controller may directly adjust the blade angle of the propeller blades 40, because the position of the mechanical slide 3 determines the blade angle of the propeller blades 40.

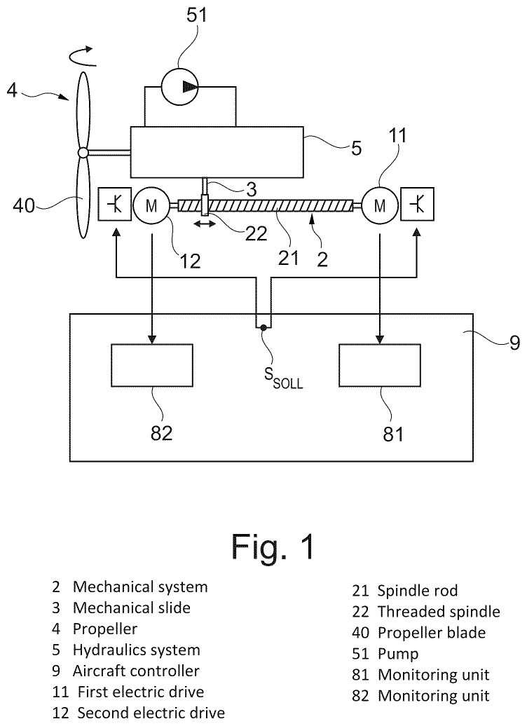

FIG. 1 shows an exemplary embodiment of an actuating device designed according to the principles of the present disclosure. The actuating device differs from the actuating device of FIG. 4 in terms of the type of drive of the mechanical system 2, which is also formed by a threaded spindle with a spindle rod 21 and a spindle nut 21 in the exemplary embodiment of FIG. 1, without this necessarily being the case.

Therefore, a first electric drive 11 and a second electric drive 12 are provided, which drive the mechanical system 2 jointly and simultaneously. Accordingly, an electric motor of the first electric drive 11 is coupled to the spindle rod 21 and an electric motor of the second electric drive 12 is also coupled to the spindle rod 21. The two electric drives 11, 12 are arranged at opposite ends of the spindle rod 21.

In this case, the two electric drives 11, 12 receive the same setpoint value S_{Soll} for the position of the mechanical slide 3 or the threaded spindle 22 (position setpoint value) from an aircraft controller 9. Both electric drives 11, 12 include a position control system, which controls the actual value of the position of the mechanical slide 3 to the position setpoint value S_{Soll}, so that the two electric drives 11, 12 jointly drive the spindle rod 21 and move the spindle nut 22 to the desired position setpoint value S_{Soll}.

The joint driving of the mechanical system 2 by the two electric drives 11, 12 has the effect that, in the event that one of the two drives fails, the other drive alone drives the mechanical system. In the event that one of the drives 11, 12 fails, there are no switchover operations. Rather, the position control of the mechanical slide 3 is maintained without interruption because, after failure of one drive, the other drive continues to drive the mechanical system.

It is further provided here that the two electric drives 11, 12 are configured, in the event that one of the electric drives fails, to not inhibit driving of the mechanical system 2, which is then further performed only by the other electric drive that has not failed. For this purpose, it is provided, in particular, that the motors of the electric drives 11, 12 are connected to the common mechanical system 2 without a self-locking mechanism. This provides that an inactive, switched-off motor may be moved by an active motor.

According to FIG. 1, it is further provided that each electric drive 11, 12 is monitored by its own monitoring unit 81, 82. Here, the monitoring function is performed separately for each electric drive 11, 12 and independently of the monitoring function of the other electric drive 11, 12. If one of the monitoring units 81, 82 identifies a fault, it switches off the associated electric drive 11, 12. The faulty electric drive 11, 12 then no longer develops any torque and is no longer involved in the position control.

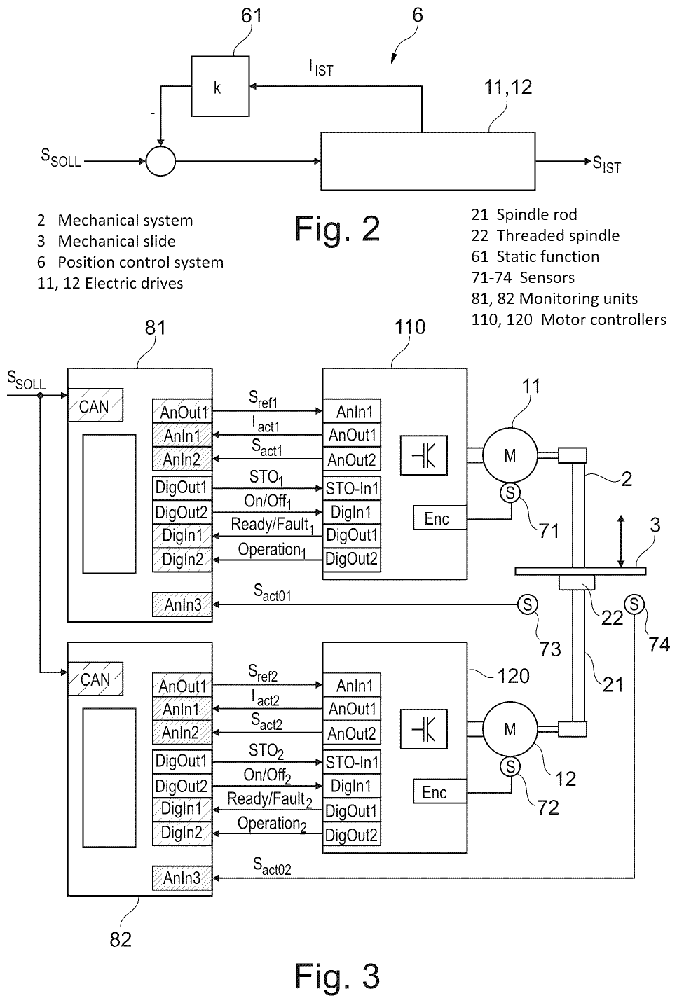

FIG. 2 schematically shows an exemplary embodiment of a position control system 6, as is implemented in the two electric drives 11, 12. The position control system 6 is used, in principle, to control the actuator, (e.g., the mechanical slide 3), to the position setpoint value S_{Soll}. For this purpose, the position actual value S₁ₛₜ is detected by a sensor (not shown) or derived from other variables such as the number of revolutions performed by the electric motor and supplied in a manner known per se as an actual value to the control system.

According to FIG. 2, the position control system 6 includes a static function 61, which has the current actual value I₁ₛₜ or a torque of the electric drive or electric motor 11, 12 derived therefrom as an input, reduces this value by a factor k depending on the actual current value or torque of the electric motor and returns the reduced value to the input of the control system. The static function 61 therefore reduces the position setpoint value S_{Soll} depending on the actual current value or torque. It therefore provides that, in the event of deviations in the position actual values of the two actuating drives 11, 12, the two electric motors do not work against one another. This may occur if, due to inaccuracies or measurement deviations in the exact detection of the position actual value, the position control systems receive different information as to whether the position setpoint value S_{Soll} has already been reached. There is then a risk of the two drives 11, 12 becoming distorted.

It is provided in this case that the factor k of the static function 61 is set the same for both electric drives 11, 12. Under this condition, the two electric drives 11, 12 share the torque, which is required to reach the setpoint position S_{Soll}, uniformly. Given the same factor k, they therefore provide exactly the same torque and share the power to adjust the mechanical slide 3.

FIG. 3 shows an exemplary embodiment of an implementation of the actuating device according to FIG. 1. The components of the two electric drives 11, 12, of the mechanical system 2 including the spindle rod 21 and the spindle nut 22, and of the mechanical slide 3, which have already been explained with reference to FIG. 1, are shown in the figure. In this respect, reference is made to the explanations relating to FIGS. 1 and 2.

The electric drive 11 is assigned a motor controller 110 and a monitoring unit 81. The electric drive 12 is assigned a motor controller 120 and a monitoring unit 82. The respective motor controllers 110, 120 and monitoring units 81, 82 are independent of one another. A position setpoint value S_{Soll} of the mechanical slide 3 is provided via an aircraft controller and supplied to the respective motor controller 110, 120 via the respective monitoring unit 81, 82. At the same time, each electric drive 11, 12 is assigned a sensor 71, 72, which detects the position actual value of the electric slide 3. The sensors 71, 72 are shown only schematically. They may detect the actual position of slide 3 either directly or indirectly, for example by counting the revolutions of the electric motor.

Position control takes place in the manner described with the position actual value and the position setpoint value, with both electric drives 11, 12 driving the mechanical system 2 jointly and simultaneously as long as both electric drives 11, 12 are functional. In the event that one of the electric drives 11, 12 fails, the other electric drive takes over the position control of the slide 3 alone, as already explained, without the need for a switchover operation and without interruption.

The initial example in FIG. 3 implements an additional monitoring function which makes it possible to detect a possible sensor fault in the sensors 71, 72. It is therefore provided that each electric drive 11, 12 is assigned a further position sensor 73, 74, which also detects the position of the mechanical slide 3. The sensor values of the further position sensors 73, 74 are read in by the respective monitoring unit 81, 82. The monitoring unit 81, 82 identifies a possible malfunction using the position actual value, which is provided by the respective electric drive 11, 12 or the sensor 71, 72, which is part of the position control system of the respective electric drive 11, 12, and using the further position actual value, which is provided by the respective further position sensor 73, 74. Such is the case, for example, when the two sensors 71, 73 and 72, 74 provide deviating values, with the deviation being above a predefined tolerance value. In addition, the current actual value of the respective electric drive 11, 12 may be evaluated for the presence of a possible malfunction. In the event of a malfunction, the respective monitoring unit 81, 82 switches off the respective electric drive 11, 12.

The actuating device, jointly with the hydraulics system 5 and the propeller 4, forms a device for adjusting the blade angles of the propeller blades of an aircraft propeller.

It is understood that the disclosure is not limited to the embodiments described above, and various modifications and improvements may be made without departing from the concepts described herein. It is furthermore pointed out that any of the features described may be used separately or in combination with any other features, provided that they are not mutually exclusive. The disclosure extends to and includes all combinations and sub-combinations of one or a plurality of features which are described here. If ranges are defined, the ranges therefore include all the values within the ranges as well as all the partial ranges that lie within a range.

It is to be understood that the elements and features recited in the appended claims may be combined in different ways to produce new claims that likewise fall within the scope of the present disclosure. Thus, whereas the dependent claims appended below depend on only a single independent or dependent claim, it is to be understood that these dependent claims may, alternatively, be made to depend in the alternative from any preceding or following claim, whether independent or dependent, and that such new combinations are to be understood as forming a part of the present specification.

1. An actuating device comprising:
a mechanical system configured to move a mechanical slide;
a first electric drive configured to drive the mechanical system, wherein the first electric drive is configured to receive a position setpoint value and drive the mechanical system to move the mechanical slide to the position setpoint value; and
a second electric drive configured to drive the mechanical system, wherein the second electric drive is configured to receive a same position setpoint value and drive the mechanical system to move the mechanical slide to the position setpoint value,
wherein the first electric drive and the second electric drive are configured to drive the mechanical system jointly and simultaneously,
wherein each electric drive of the first electric drive and the second electric drive is configured to drive the mechanical system alone in event that the other electric drive fails, and
wherein the first electric drive and the second electric drive are configured, in the event that either the first electric drive or the second electric drive fails, to not inhibit driving of the mechanical system, which is then performed only by the other electric drive.

2. The actuating device of claim 1, wherein the mechanical system is configured as a threaded spindle and comprises a spindle rod and a spindle nut,
wherein the first electric drive and the second electric drive are configured to jointly drive the spindle rod, and
wherein the spindle nut arranged on the spindle rod is connected to the mechanical slide, so that the mechanical slide is configured to move to the position setpoint value when the spindle rod is driven.

3. The actuating device of claim 2, wherein the first electric drive and the second electric drive are arranged at opposite ends of the threaded spindle.

4. The actuating device of claim 1, wherein the mechanical slide (3) is connected to a hydraulics system (5), which adjusts blade angles of propeller blades of an aircraft propeller depending on a position of the mechanical slide.

5. The actuating device of claim 1, wherein the first electric drive and the second electric drive each comprises a position control system, and
wherein a position actual value of the mechanical slide is controlled to the position setpoint value via the position control system of the respective electric drive.

6. The actuating device of claim 5, wherein the position control system of the first electric drive and the position control system of the second electric drive each is a static function (61), which causes the mechanical slide (3) to be controlled to the position setpoint value (S_{Soll}) with a tolerance value.

7. The actuating device of claim 6, wherein the tolerance value is configured to reduce the position setpoint value depending on a current torque or power requirement of the respective electric drive.

8. The actuating device of claim 7, wherein a factor, by which the position setpoint value is configured to be reduced depending on the current torque or the power requirement of the respective electric drive, is identical for both the first electric drive and the second electric drive.

9. The actuating device of claim 5, wherein the position actual value of the position control system of the first electric drive and the position control system of the second electric drive is configured to be measured by at least one sensor.

10. The actuating device of claim 1, wherein the first electric drive and the second electric drive each comprises an electric motor coupled to the mechanical system without a self-locking mechanism.

11. The actuating device of claim 1, wherein the first electric drive and the second electric drive are each assigned a monitoring module,
wherein the respective monitoring module is configured to monitor the assigned drive independently of the other drive and it switch the assigned drive off in an event that a fault is identified.

12. The actuating device of claim 11,
wherein the first electric drive and the second electric drive each comprises a position control system,
wherein a position actual value of the mechanical slide is controlled to the position setpoint value via the position control system of the respective electric drive,
wherein the position actual value of the position control system of the first electric drive and the position control system of the second electric drive is configured to be measured by a first sensor,
wherein the first electric drive and the second electric drive is each is assigned a second sensor configured to additionally detect the position actual value of the mechanical slide, and
wherein the position actual value detected by the second sensor is configured to be read in by the respective monitoring module and each monitoring module is configured to identify a possible malfunction from the position actual value of the position control system and the position actual value detected by the second sensor and to switch off the associated electric drive in such a case.

13. The actuating device wherein the actuating device is configured to receive the position setpoint value of the mechanical slide from an aircraft controller.

14. The actuating device of claim 1, wherein the mechanical system is configured to move the mechanical slide linearly along a longitudinal direction of the mechanical system.

15. A device for adjusting blade angles of propeller blades of an aircraft propeller, the device comprising:
the aircraft propeller comprising the propeller blades, wherein the blade angles of the propeller blades are configured to be adjusted;
a hydraulics system configured to adjust the blade angles of the propeller blades; and
an actuating device comprising:
a mechanical system configured to move a mechanical slide;
a first electric drive configured to drive the mechanical system, wherein the first electric drive is configured to receive a position setpoint value and drive the mechanical system to move the mechanical slide to the position setpoint value; and
a second electric drive configured to drive the mechanical system, wherein the second electric drive is configured to receive a same position setpoint value and drive the mechanical system to move the mechanical slide to the position setpoint value,
wherein the first electric drive and the second electric drive are configured to drive the mechanical system jointly and simultaneously,
wherein each electric drive of the first electric drive and the second electric drive is configured to drive the mechanical system alone in event that the other electric drive fails, and
wherein the first electric drive and the second electric drive are configured, in the event that either the first electric drive or the second electric drive fails, to not inhibit driving of the mechanical system, which is then performed only by the other electric drive,
wherein the hydraulics system is configured to receive a blade angle setpoint value via a position of the mechanical slide.
